(19) United States
(12) Patent Application Publication
(10) Pub. No.: US 2024/0304855 A1
(43) Pub. Date: Sep. 12, 2024

(54) INORGANIC SOLID ELECTROLYTE INTERPHASE LAYERS, BATTERIES CONTAINING THE SAME, AND METHODS OF MAKING THE SAME

(71) Applicant: BOARD OF REGENTS, THE UNIVERSITY OF TEXAS SYSTEM, Austin, TX (US)

(72) Inventors: Gyeong S. HWANG, Austin, TX (US); Swastik BASU, Austin, TX (US)

(21) Appl. No.: 18/572,063

(22) PCT Filed: Jun. 21, 2022
(86) PCT No.: PCT/US2022/034271

§ 371 Date: Dec. 19, 2023

Related U.S. Application Data
(60) Provisional application No. 63/212,795, filed on Jun. 21, 2021.

(51) Int. Cl. H01M 10/0562; H01M 4/134; H01M 4/36

(52) U.S. Cl. CPC H01M 10/0562; H01M 4/134; H01M 4/366

(57) ABSTRACT

Disclosed is an electrode material comprising: an anode metal material having an electrochemically active surface; and a substantially inorganic solid electrolyte interphase material, wherein at least a portion of the substantially inorganic solid electrolyte interphase material comprises an amorphous halide salt of one or more metals, wherein the one or more metals comprise the anode metal material, and wherein the substantially inorganic electrolyte interphase material is disposed on the electrochemically active surface.

### CROSS-REFERENCE TO RELATED APPLICATIONS

This application claims the benefit of U.S. Provisional Application No. 63/212,795 filed Jun. 21, 2021, the content of which is incorporated herein by reference in their entirety.

### TECHNICAL FIELD

This application relates generally to inorganic solid electrolyte interphase layers and batteries comprising the same.

### BACKGROUND

Electrolytes are susceptible to reductive decomposition on the surface of negative electrodes leading to the formation and growth of the solid-electrolyte interphase (SEI) layer. While the SEI is critical to the operability of various batteries, and especially of lithium-ion batteries (LIBs), the conditions under which it is formed significantly affect battery performance, namely cell impedance, irreversible capacity loss, and thermal stability, and rate of capacity fade at higher charge rates. In particular, a growth of dendrites during cycling is known to result in continuous electrolyte degradation through the destruction of the SEI. In lithium batteries, the formation of so-called “dead lithium” is also observed, which can result in short-circuiting of the battery if the dendrite reaches the positive electrode. Especially for next-generation electric vehicles (EVs), all-solid-state lithium-metal batteries (ASSLMBs) have garnered considerable attention due to their advantages in terms of energy storage capacity and safety over LIBs. However, the large interfacial impedance originating from poor physical contact and/or parasitic reactions at the Li/SSE interface hinders the development of ASSLMs. The interfacial stability and compatibility greatly affect the electrochemical performance of not only ASSLMs but also LIBs. Therefore, it is critical to devise strategies for the formation of an effective interfacial layer at the electrode/electrolyte interface that can suppress electrolyte decomposition and Li dendrite propagation by blocking electron transport while allowing lithium ions to readily travel through it during cycling.

Thus, new approaches to provide for stable solid electrolyte interphase (SEI) that address these needs are needed. Electrochemical cells utilizing these new stable solid electrolyte interphase (SEI) layers are also needed. These needs and other needs are at least partially satisfied by the present disclosure.

### SUMMARY

The present disclosure is directed to an electrode material comprising: an anode metal material having an electrochemically active surface; and a substantially inorganic solid electrolyte interphase material, wherein at least a portion of the substantially inorganic solid electrolyte interphase material comprises an amorphous halide salt of one or more metals, wherein the one or more metals comprise the anode metal material, and wherein the substantially inorganic electrolyte interphase material is disposed on the electrochemically active surface.

Also disclosed herein are aspects wherein the anode metal material comprises an alkali or an alkaline-earth metal material. Also disclosed are aspects where the halide salt comprises a chloride salt, a fluoride salt, a bromide salt, an iodide salt of the anode metal material, or a combination thereof. In still further aspects, the disclosed herein amorphous halide salt can exhibit an ion conductivity ranging from 1 mS/cm to about 20 mS/cm.

In still further aspects, the disclosed herein amorphous halide can be doped with at least one heteroatom and/or polyanion.

Also disclosed herein is a battery comprising any one of the disclosed herein electrode materials. In yet further aspects, the battery can also comprise an electrolyte. In yet further aspects, the battery disclosed herein can further comprise a cathode material.

In still further aspects, disclosed herein is a thin film comprising an amorphous halide salt comprising a metal cation of an alkali metal or alkaline-earth metal. In yet still further aspects, the disclosed herein thin film can comprise an amorphous halide salt that is doped with at least one heteroatom.

In yet still, further aspects disclosed herein is a solid ion-conducting composite comprising: a) a thin film solid electrolyte comprising one or more of sulfide compounds, garnet structure oxides, LISICON-type solids, NASICON-type phosphate glass ceramics, perovskite-type and anti-perovskite type compounds, nitrides, oxynitrides, argyrodite-type, polymer-based electrolytes, or any combination thereof, and b) a protective layer comprising the amorphous thin film as disclosed herein and disposed on the thin film solid electrolyte surface.

In still further aspects, disclosed herein is a method of making any of the disclosed herein electrode materials, wherein the methods comprise depositing or in-situ forming the substantially inorganic solid electrolyte interphase material on the electrochemically active surface of the anode metal material.

Also disclosed are methods of making any of the disclosed herein batteries comprising a) providing any of the disclosed herein electrode materials, b) providing an electrolyte, and c) providing a cathode material.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIGS. 1A-1B depict schematic representations of interstitial Li diffusion via direct hopping (FIG. 1A) and knock-off mechanisms (FIG. 1B). The lighter and darker balls represent Li and F atoms, respectively. The initial and final positions of interstitial Li in the case of direct hopping are marked as i and f. In the case of the knock-off mechanism, the initial and final positions of the interstitial Li are marked as i and f₁, while the final position of the displaced atom (discernably distinguished as the bigger atom in the LiF lattice) is marked as f.

FIG. 2A depicts predicted diffusion coefficients of Li in crystalline LiF (c-LiF) and amorphous LiF (a-LiF). V.H., I.H., I.K. refer to Vacancy Hopping, Interstitial Hopping, and Interstitial Knock-off mechanisms, respectively, in c-LiF. FIG. 2B depicts the density of states (DOS) of c-LiF and a-LiF. The vertical dashed line indicates the Fermi level position in c-LiF, and the Li metal Fermi level position is also marked. The atomic structures of c-LiF and a-LiF are shown in the inset, where the lighter and darker balls represent Li and F atoms, respectively.

FIG. 3 depicts variations in the internal energy (E) per LiF pair for the crystalline and amorphous phases of LiF as a function of volume. All E values are shifted with respect to the minimum energy configuration of c-LiF. Corresponding crystalline and amorphous structures are shown in the inset; lighter and darker balls represent Li and F atoms, respectively.

FIG. 4A depicts snapshots from AIMD simulations, before and after annealing at 300K for 25 ps, for LiF(N) systems with different N contents (x=5.7%, 7.8%, 9.9%). FIG. 4B depicts variations in the internal energy (E) per LiF pair for crystalline and amorphous N-doped LiF(N) systems with varying N contents (x=0%, 6.7%, 9.1%, 11.6%, 14.3%), as a function of volume per LiF pair. lighter, darker balls represent Li, F; and the biggest balls represent N in the bulk structure schematics.

FIG. 5A depicts Predicted ionic conductivity (σLi) in bulk c-LiF, a-LiF, and a-LiF(N). FIG. 5B depicts the density of states (DOS) of c-LiF and a-LiF(N) with two different N contents (x=14%, 25%). The vertical dashed line indicates the Fermi level position in a-LiF(N). Inset shows band-decomposed charge density isosurfaces (±0.06 e/A3) for the localized states in the bandgap as indicated with a parenthesis.

FIG. 6A-6B depicts snapshots from first-principles simulations showing the failure of c-LiF [A] and a-LiF [B] bulk structures under tensile strains (ϵ); each structure contains 108 LiF pairs. FIG. 6C depicts DFT-predicted moduli values of c-LiF and a-LiF, where B, E, and G refer to Bulk modulus, Young's modulus, Shear modulus, respectively, and γ is Poisson's ratio.

FIGS. 7A-7B depict snapshots from first-principles simulations showing the failure of bulk interfacial structures containing Li:c-LiF interface and Li:a-LiF(N) interface under tensile strains (c); Lighter and darker balls (small) represent Li and F with the larger balls representing N doped into LiF.

FIG. 8 depicts schematic representations of the interfaces between metallic Li and amorphous LiF, LPS and LiF (doped-amorphous/undoped-crystalline), LiPON, and LiF (doped-amorphous/undoped-crystalline). Lighter and darker balls (small) represent Li and F, with the larger balls representing heteroatoms doped into LiF. LPS and LiPON are marked in the figure.

FIG. 9 depicts schematic representations of the well-dispersed as well as clustered/segregated heteroatoms, subsequently classified as desirable for amorphous phase stabilization or undesirable, respectively. Lighter and darker balls (small) represent Li and F, while the larger balls represent different heteroatoms doped into LiF, as marked in the figure.

FIG. 10 depicts the true strain-true stress curves for the uniaxial tensile testing of c-LiF and a-LiF(N), a-LiF(O), and a-LiF(CO₃) bulk samples obtained from the AIMD simulations. The a-LiF samples here are infused with heteroatomic dopants previously classified as desirable for amorphous phase stabilization.

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a salt” includes two or more such salts, reference to “a battery” includes two or more such batteries, and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms that shall be defined herein.

For the terms “for example” and “such as,” and grammatical equivalences thereof, the phrase “and without limitation” is understood to follow unless explicitly stated otherwise.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that, although the terms “first,” “second,” etc., may be used herein to describe various elements, components, regions, layers, and/or sections.

These elements, components, regions, layers, and/or sections should not be limited by these terms. These terms are only used to distinguish one element, component, region, layer, or section from another element, component, region, layer, or section.

Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate, effective amount will be readily determined by one of ordinary skill in the art using only routine experimentation.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

As disclosed above, the current disclosure is directed to an electrode material comprising: an anode metal material having an electrochemically active surface; and a substantially inorganic solid electrolyte interphase material, wherein at least a portion of the substantially inorganic solid electrolyte interphase material comprises an amorphous halide salt of one or more metals, wherein the one or more metals comprise the anode metal material, and wherein the substantially inorganic electrolyte interphase material is disposed on the electrochemically active surface.

In certain aspects, the anode metal material can comprise an alkali metal. Yet, in other aspects, the anode metal material can comprise an alkaline-earth metal material. In yet still further aspects, the anode metal material can comprise alloys of the alkali metal, alloys of the alkaline-earth metal material, or alloys of the alkali and the alkaline-earth metal materials.

In still further aspects, the anode metal material can comprise lithium, sodium, potassium, magnesium, aluminum, or alloys thereof. In still further aspects, the anode material is lithium. While in other aspects, the anode material is sodium. While in still further aspects, the anode material is potassium. Yet, in still further aspects, the anode material is magnesium. While in still further aspects, the anode material is aluminum. It is also understood that the anode material can be an alloy or a combination of alloys of any of the disclosed above metals.

Also disclosed are aspects where the halide salt can comprise a chloride salt, a fluoride salt, a bromide salt, an iodide salt of the anode metal material, or a combination thereof. It is understood that if the combination of halide salts is present, each of the present halide salt can be in any amount relative to each other. In still further aspects, the halide salt is amorphous lithium fluoride. Yet, in certain aspects, the halide salt can be amorphous sodium fluoride, or amorphous potassium fluoride, or amorphous magnesium fluoride, or amorphous aluminum fluoride, or a combination thereof. Similarly, it can be lithium chloride or sodium chloride, and so on.

In still further aspects, and as disclosed above, the halide salt can be a halide salt of one or more metals. In such exemplary aspects, the one or more metals can further comprise an alkali or an alkaline-earth metal material that is different from the anode metal material.

In still further aspects, the amorphous halide salt is present as a continuous thin film. However, in certain exemplary and unlimiting aspects, the amorphous halide salt can be present as a discontinuous film if desired. It is understood that if desired, a specific pattern of the substantially inorganic solid interphase electrolyte can also be obtained.

In still further aspects, the electrode material disclosed herein can have the amorphous halide salt exhibiting an ion conductivity ranging from about 1 mS/cm to about 20 mS/cm, including exemplary values of about 2 mS/cm, about 5 mS/cm, about 7 mS/cm, about 10 mS/cm, about 12 mS/cm, about 15 mS/cm, and about 17 mS/cm.

In yet further aspects, the amorphous halide salt can exhibit an ion conductivity ranging from about 12 mS/cm to about 20 mS/cm, including exemplary values of about 12 mS/cm, about 14 mS/cm, about 15 mS/cm, about 16 mS/cm, about 17 mS/cm, about 18 mS/cm, and about 19 mS/cm.

In still further aspects, the disclosed herein amorphous halide salt is substantially an electrical insulator. In certain aspects, the amorphous halide salt exhibits an electronic conductivity of less than about 10⁻⁹ S cm⁻¹, less than about 10⁻¹⁰ S cm⁻¹, or even less than about 10⁻¹¹ S cm⁻¹. Yet, in other aspects, the amorphous halide salt exhibits electrical resistivity greater than about 10⁷ Ω·cm, greater than about 10⁸ Ω·cm, greater than about 10⁸ Ω·cm, greater than about 10¹⁰ Ω·cm, or even greater than about 10¹¹ Ω·cm.

In still further aspects where the halide salt comprises a metal cation that is substantially identical to the anode metal material, such a metal anode cation can have a self-diffusion coefficient in the amorphous halide salt from about 5×10⁻¹⁰ to about 10⁻⁷ cm²/s, including exemplary values of about 1×10⁻⁹, about 5×10⁻⁹, about 1×10⁻⁸, about 5×10⁻⁸, and about 1×10⁻⁷.

In still further aspects, the substantially inorganic solid electrolyte interphase material can comprise a combination of crystalline and amorphous phases of the halide salt. In such aspects, at least about 5% of the substantially inorganic solid electrolyte interphase material is amorphous, at least about 10% of the substantially inorganic solid electrolyte interphase material is amorphous, at least about 15% of the substantially inorganic solid electrolyte interphase material is amorphous, at least about 20% of the substantially inorganic solid electrolyte interphase material is amorphous, at least about 25% of the substantially inorganic solid electrolyte interphase material is amorphous, at least about 30% of the substantially inorganic solid electrolyte interphase material is amorphous, at least about 35% of the substantially inorganic solid electrolyte interphase material is amorphous, at least about 40% of the substantially inorganic solid electrolyte interphase material is amorphous, at least about 45% of the substantially inorganic solid electrolyte interphase material is amorphous, at least about 50% of the substantially inorganic solid electrolyte interphase material is amorphous, at least about 55% of the substantially inorganic solid electrolyte interphase material is amorphous, at least about 60% of the substantially inorganic solid electrolyte interphase material is amorphous, at least about 65% of the substantially inorganic solid electrolyte interphase material is amorphous, at least about 70% of the substantially inorganic solid electrolyte interphase material is amorphous, at least about 75% of the substantially inorganic solid electrolyte interphase material is amorphous, at least about 80% of the substantially inorganic solid electrolyte interphase material is amorphous, at least about 85% of the substantially inorganic solid electrolyte interphase material is amorphous, at least about 90% of the substantially inorganic solid electrolyte interphase material is amorphous, at least about 95% of the substantially inorganic solid electrolyte interphase material is amorphous, at least about 99 of the substantially inorganic solid electrolyte interphase material is amorphous, and 100% of the substantially inorganic solid electrolyte interphase material is amorphous. In some exemplary aspects, the substantially inorganic solid electrolyte interphase material is the amorphous halide salt.

In still further aspects, the substantially inorganic solid electrolyte interphase material is configured to substantially wet the electrochemically active surface of the anode metal material. In still further aspects, the substantially inorganic solid electrolyte interphase material exhibits a substantially ductile behavior under stress. Without wishing to be bound by any theory, it is understood that such ductile behavior is due to the presence of the amorphous halide salt. It is further understood that in aspects where the substantially inorganic solid electrolyte interphase material only comprises a crystalline phase, the ductile behavior is not observed.

In still further aspects, the interfacial solid electrolyte interphase material is substantially stable at room temperature. While in other aspects, when the disclosed electrode materials are used in a battery configuration or any other electrochemical configuration, the interfacial solid electrolyte interphase material is also stable under the battery operating conditions or under other operating conditions of the electrochemical configuration.

In still further aspects, the amorphous halide salt can have a volumetric strain greater than 0% and less than 100%, including exemplary values of about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 80%, and about 95%. In yet still further aspects, the amorphous halide salt can have a volumetric strain between about 10% and about 30%, including exemplary values of about 12%, about 15%, about 17%, about 20%, about 22%, about 25%, and about 28%.

In still further aspects, the amorphous halide salt can be dopped with at least one heteroatom and/or polyanion. Without wishing to be bound by any theory, it was hypothesized that the incorporation of heteroatoms and/or polyanions in an effective amount can make an amorphous phase of the halide salt more thermodynamically favorable while maintaining the aforementioned favorable transport, electronic, mechanical, and interfacial properties. It is understood that any known doping heteroatoms and/or polyanions suitable for the desired application can be used. It is also understood that depending on the application, the at least one doping heteroatom and/or polyanion can be selected based on the atom size, interactions with the halide salt, the desired change in the diffusivity of the cation used in the halide salt, and desired strain and volume change in the amorphous structure. It is also understood that the at least one doping heteroatom and/or polyanion can be used whether the halide salt is fully amorphous or has a combination of the amorphous and crystalline phases.

In still further aspects, the at least one heteroatom can comprise N, O, C, S, or a combination thereof. In yet still further aspects, the at least one heteroatom can be present as a combination of the heteroatoms that form a compound together. For example, the doping can comprise a single heteroatom, polyanion (carbonate, sulfate, nitride sulfate, nitrate), or any combination thereof. It is understood that if polyanions are used as dopants, these polyanions can include a cation of a metal of interest.

Without wishing to be bound by any theory, it is hypothesized that because of the amorphous nature of the composite, the dopants will be able to interchangeably combine with any cation in its vicinity, and hence the high ionic conductivity will be maintained.

In still further aspects, the at least one heteroatom and/or polyanion is present in an amount from about 5% to greater than 100%, including exemplary values of about 10%, about 20%, about 25%, about 30%, about 35%, about 45%, about 50%, about 55%, about 60%, about 65%, about 70%, about 75%, about 80%, about 85%, about 90%, about 95%, about 100%, and between 100% and 500%, based on the atomic percentage of the dopant measured against LiF.

In further aspects, the distribution of heteroatom and/or polyanion includes a dispersion of localized clusters of various sizes according to design, acting as amorphous phase stabilizers as well as reinforcements for enhanced mechanical strength. Without wishing to be bound by any theory, the dopants will be able to interchangeably combine with any cation in its vicinity; the localized clusters will be rich in such dopant-cation combinations.

In still further aspects, the disclosed herein substantially inorganic solid electrolyte interphase material is formed ex-situ and/or in-situ when the electrode material is in contact with an electrolyte. In such exemplary aspects, the electrolyte that is in contact with the disclosed herein substantially inorganic solid electrolyte interphase material can be solid or liquid depending on the desired application.

In yet other aspects, the substantially inorganic solid electrolyte interphase material is configured to substantially prevent the formation of dendrites on the electrochemically active surface of the anode metal material. While in still further aspects, the substantially inorganic solid electrolyte interphase material is configured to substantially suppress decomposition of the electrolyte when it is in contact with the electrolyte.

For example, a conventional, low-cost poly(ethylene oxide) (PEO)-based composite polymer electrolytes exhibit relatively high ionic conductivity at room temperature (10⁻⁵ up to 10⁻⁴ S cm⁻¹), but their low critical current density promotes quick lithium dendrite growth at current densities above 0.3 mA cm⁻². When such an electrolyte is used with the disclosed herein electrode materials, the electrolyte decomposition and formation of dendrites can be suppressed.

In still further aspects, the substantially inorganic solid electrolyte interphase material the current disclosure can have a thickness between about 1 nm to about 500 nm, including exemplary values of about 5 nm, about 10 nm, about 20 nm, about 30 nm, about 40 nm, about 50 nm, about 60 nm, about 70 nm, about 80 nm, about 90 nm, about 100 nm, about 150 nm, about 200 nm, about 250 nm, about 300 nm, about 350 nm, about 400 nm, and about 450 nm.

Still further disclosed herein is a battery. In such aspects, the battery can comprise any of the disclosed above electrode materials. In still further aspects, the battery comprises an electrolyte. As discussed above, the electrolyte can be solid or liquid depending on the desired application.

In still further aspects, when the electrolyte is solid, the substantially inorganic solid electrolyte interphase material is configured to substantially wet a surface of such solid electrolyte.

In still further aspects, the solid electrolyte can comprise sulfide compounds, garnet structure oxides, LISICON-type solids, NASICON-type phosphate glass ceramics, perovskite-type and anti-perovskite type compounds, nitrides, oxynitrides, argyrodite-type, or polymer-based electrolytes, or any combination thereof. If the electrolyte is polymer-based electrolytes, such electrolytes can further comprise an alkali metal, an alkaline-earth metal salt, or a combination thereof.

In still further aspects, the alkali metal salt or alkaline-earth metal salt can comprise any of the alkali metal salt that is suitable for the desired application. It is also understood that the alkali metal salt or alkaline-earth metal salt composition can be defined by the final use. For example, if the solid electrolyte is designed for use in a lithium electrochemical cell, the alkali metal salt can comprise Li cations. However, it is also understood that if the solid electrolyte is designed for use in sodium or potassium electrochemical cells, the alkali metal salt can comprise Na or K cations and the like.

In still further aspects, the alkali metal salt comprises one or more of bis(trifluoromethane)sulfonimide lithium salt (LiTFSI), lithium perchlorate (LiClO₄), lithium tetrafluoroborate (LiBF₄), lithium hexafluorophosphate (LiPFe), lithium hexafluroarsenate (LiAsFe), lithium bis(fluorosulfonyl)imide (LiFSI), lithium aluminum tetrachloride (LiAlCl₄), lithium boron tetrachloride (LiBCl₄), lithium iodide (Lil), lithium chlorate (LiCIO₃), LiBrO₃. LiIO₃, or a combination thereof.

In still further aspects, the polymer can comprise poly(ethylene oxide) (PEO) polymer, polyethylene glycol (PEG), polyvinylidene fluoride (PVDF), poly(vinyl alcohol) (PVA), poly(vinyl chloride) (PVC), polyacrylonitrile (PAN), poly(methyl methacrylate) (PMMA), poly(vinylidene fluoride-co-hexafluoropropylene) (PVdF-HFP), or any combination thereof. In still further aspects, the polymer can comprise a mixture of the polymers, for example, and without limitations, such as a cross-linked polymer blend comprising PEO or PEO-PVDF may be selected.

In still further aspects, the solid electrolyte can further comprise a lithium germanium phosphorous sulfide electrolyte, a lithium phosphorus oxynitride electrolyte, a lithium phosphorous sulfide electrolyte, lithium lanthanum zirconium oxide, lithium lanthanum titanium oxide, lithium aluminum germanium phosphate, lithium nitride, or any combination thereof.

In some aspects, the electrolyte is a liquid electrolyte. In such aspects, the electrolyte comprises a salt of a metal cation and a non-aqueous organic solvent. Again, it is understood that the metal cation can be chosen depending on the desired application and can be the same or different as a metal cation present in the halide salt and/or metal anode material. In some aspects, the metal cation can comprise lithium, sodium, potassium, magnesium, aluminum, or a combination thereof.

In still further aspects, any of the known in the art non-aqueous solvents that are traditionally used in the field of batteries and electrochemical devices can be utilized. In some aspects, the non-aqueous organic solvent can comprise an ethylene carbonate, dimethyl carbonate, diethyl carbonate, propylene carbonate, dimethoxyethane, ethyl methyl carbonate, N-methyl acetamide, acetonitrile, symmetric sulfone, sulfolane, polyethylene glycol, 1,3-dioxolane, glymes, siloxane, ethylene oxide grafted sulfolane, or a combination thereof.

In still further aspects, the batteries disclosed herein are configured to operate in a temperature range from about 20° C. up to about 80° C., including exemplary values of about 25° C., about 30° C., about 35° C., about 40° C., about 45° C., about 50° C., about 55° C., about 60° C., about 65° C., about 70° C., and about 75° C.

The battery of the present disclosure can further comprise a cathode. It is understood that any known in the art cathode materials that can be useful for the desired purpose can be utilized. In some aspects, the cathode can be a metal cathode or composite cathode. If the metal cathode is used, such an electrochemical cell can be a symmetrical electrochemical cell. In such an exemplary aspect, when the electrochemical cell is symmetrical, both anode and cathode comprise the same material, for example, and without limitation, it can comprise Li. In other words, there are some exemplary aspects, where the anode material of the electrochemical cell is Li and the cathode material used in the same cell is also Li.

In still further aspects, the cathode material can be a composite material. In such aspects, if the electrochemical cell is a lithium electrochemical cell, any known in the art cathode materials that are useful in the Li cell can be utilized. If the electrochemical cell is K or Na cell, any known in the art cathode materials that are useful in Na or K cells can be utilized.

In some aspects, the cathode comprises copper, carbon, graphite, sodium, lithium, layered oxides, spinels, olivines, or any combination thereof.

Yet, in still further aspects, the cathode comprises a composite material comprising A-MnO₂, LiMn₂O₄ spinel, olivine LiFePO₄, FePO₄, layered LiCoO₂ (LCO), LiNi_{y}Mn_{y}Co_{1-2y}O₂ (NMC), LiNiMnO₂, or any combination thereof.

In yet still further aspects, the cathode can comprise a LiFePO₄ composite cathode, a LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, or a LiNi_{0.8}Mn_{0.2}Co_{0.2}O₂ composite cathode. In yet still further aspects, the cathode material can also comprise a poly(ethylene oxide), cellulose, carboxymethylcellulose (CMC), a polytetrafluoroethylene (PTFE), styrene-butadiene rubber (SBR), or a polyvinylidene fluoride binder, or a combination thereof.

In still further aspects, the disclosed herein batteries can be primary or secondary. Yet, in still further aspects, the disclosed herein batteries can be secondary batteries.

By way of example, the disclosed batteries can be used in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicles, such as a boat, submarine, bus, train, truck, car, motorcycle, moped, powered bicycle, airplane, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries, containing at least about 10, at least about 100, at least about 500, between 10 and 10,000, between 100 and 10,000, between 1,000 and 10,000, between 10 and 1000, between 100 and 1,000, or between 500 and 1,000 electrochemical cells of the present disclosure. Cells in multi-cell batteries may be arranged in parallel or in series.

Also disclosed herein thin films comprising any of the disclosed above amorphous halide salts. In such aspects, the amorphous halide slat comprises a metal cation of an alkali metal or alkaline-earth metal and a halide. Any of the disclosed above metal cations and halides can be present in the thin film.

It is further understood that the thin film can have a thickness similar to the thickness of the substantially inorganic solid electrolyte interphase material, as disclosed above. While in other aspects, the thickness can be greater. For example, the thickness of the thin film can be greater than disclosed above 500 nm; it can also be greater than about 600 nm, or greater than about 700 nm, or greater than about 800 nm, or greater than about 900 nm, or greater than about 1 μm. It is understood that if needed, this film can be formed on a micrometer scale.

It is further understood that the thin film disclosed herein can comprise amorphous halide salt in any amount. In some aspects, the film is a substantially amorphous phase of the halide salt. While in other aspects, the thin film can have a combination of crystalline and amorphous phases.

In still further aspects, and as disclosed above, the thin film can be stable at ambient conditions. In some aspects, the amorphous halide salt film can have any of the disclosed above volumetric strains. While in other aspects, the amorphous halide salt film can have any of the disclosed above heteroatoms and/or polyanions as dopants.

In still further aspects, also disclosed herein is a solid ion-conducting composite comprising: a) a thin film solid electrolyte comprising one or more of sulfide compounds, garnet structure oxides, LISICON-type solids, NASICON-type phosphate glass ceramics, perovskite-type and anti-perovskite type compounds, nitrides, oxynitrides, argyrodite-type, polymer-based electrolytes, or any combination thereof, and b) a protective layer comprising the amorphous thin film as disclosed herein and disposed on the thin film solid electrolyte surface.

It is understood that such a solid ion-conducting composite can be used in any of the disclosed herein batteries. For example, this solid ion-conducting composite can be used as an electrolyte that is in contact with the disclosed above electrode material. In such exemplary and unlimiting aspects, the protective layer formed on the solid electrolyte and the substantially inorganic solid electrolyte interphase material is the same or different. It is understood that in some aspects, the composition of the protective layer and the substantially inorganic solid electrolyte interphase material can be the same or different. In yet other aspects, the thickness or percentage of the amorphous phase relative to the crystalline phase can be the same or different. In yet other aspects, the percentage of doping or strain stress of the protective layer and the substantially inorganic solid electrolyte interphase material can be the same or different.

In still further aspects, the solid ion-conducting composite disclosed herein can be used with electrode materials that do not comprise the substantially inorganic solid electrolyte interphase material disclosed above. In certain aspects, the solid ion-conducting composite can be used with an anode metal material such that the protective layer of the solid ion-conducting composite is in contact with the anode. In such exemplary and unlimiting aspects, the anode metal material can be a metal whose electrochemically active surface can comprise any passivating or other functional and non-functional films disposed on its electrochemically active surface, or it can be an untreated virgin surface, or it can be polished to ensure that the electrochemically active surface comprises a pure metal.

In still further aspects, the protective layer of the solid ion-conducting composite disclosed herein is configured to substantially wet an electrochemically active surface of any of the above-disclosed anode metal materials if present. In still further aspects, the protective layer is configured to substantially prevent the formation of dendrites on the electrochemically active surface of the anode metal material under any operating conditions. In still further aspects, the protective layer is configured to substantially suppress decomposition of the thin film solid electrolyte when it is under operating conditions.

Further disclosed herein are methods of making any of the disclosed herein electrode materials comprising ex-situ depositing or in-situ forming the substantially inorganic solid electrolyte interphase material on the electrochemically active surface of the anode metal material. In such aspects, the step of the ex-situ deposition can comprise any methods known in the art and suitable for the desired application. For example, and without limitations, the steps of the ex-situ deposition can comprise a plasma deposition, an atomic layer deposition, a molecular layer deposition, a chemical vapor deposition, a gas-phase deposition, a solution deposition, an electrochemical deposition, or any combination thereof.

In still other aspects, the in-situ formation can occur when any of the disclosed herein anode metal materials is in contact with an inorganic solid electrolyte and wherein the substantially inorganic solid electrolyte interphase material is a reaction product between the anode metal material and the electrolyte. For example, and without limitations, the in-situ formation of the substantially inorganic solid electrolyte interphase material can comprise: forming a first halide salt on the electrochemically active surface of the anode material prior to contact with an inorganic solid electrolyte; forming a second halide salt on of the inorganic solid electrolyte prior to contact with the electrochemically active surface of the anode material; exposing the electrochemically active surface of the anode material to the inorganic solid electrolyte; wherein the substantially inorganic solid electrolyte interphase material is a reaction product between the first halide salt and the second halide salt.

Other methods disclosed herein also include a method of making the disclosed herein solid ion-conducting composites. Such methods of formation of the herein disclosed composites include reaction with suitable precursors, direct mixing, molten infusion, melt-quench method of formation, etc., followed by depositing of any one of the disclosed herein protective layers on a surface of the thin film solid electrolyte. Again, any known in the art deposition methods suitable for the desired application can be used. In some exemplary and unlimiting aspects, the step of depositing can comprise a plasma deposition, an atomic layer deposition, a molecular layer deposition, a chemical vapor deposition, a gas-phase deposition, a solution deposition, an electrochemical deposition, or any combination thereof.

In yet still further aspects, also disclosed herein are methods of forming a battery, where these methods comprise a) providing any of the disclosed herein electrode materials; b) providing any of the disclosed herein or known in the art and suitable for the desired application electrolytes; and c) providing any of the disclosed herein or known in the art and suitable for the desired application cathode materials.

By way of non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

### Example 1

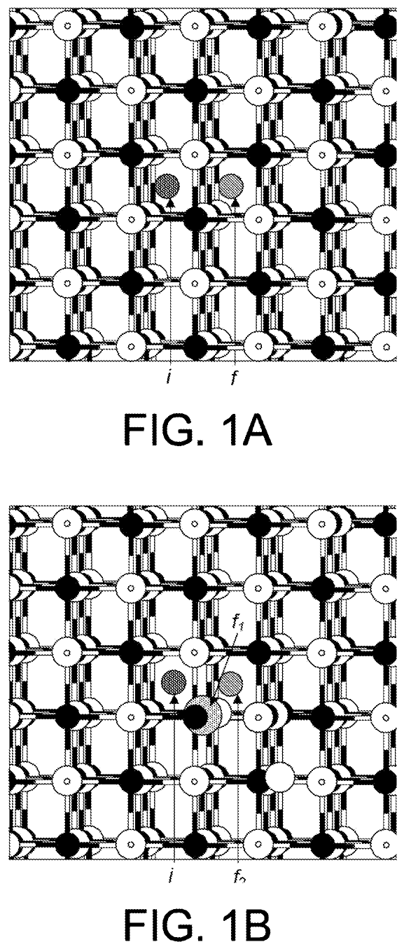

First, the Li-ion diffusivity in crystalline LiF was reviewed by calculating the migration barriers for point defects (interstitial Li; vacancy) in LiF, considering multiple diffusion mechanisms. For the vacancy defect, a direct hopping mechanism (position of the vacancy is exchanged with a neighboring Li lattice site) was considered (FIG. 1A). For interstitial Li (Liⁱ) defect, the studied diffusion mechanisms have included an interstitial hopping (Liⁱ hops onto the neighboring interstitial site) and knock-off (Liⁱ displaces Li on a neighboring lattice site) energy barrier. The migration barriers were obtained for these defects using the Nudged Elastic Band (NEB) method and are shown in Table 1, together with the diffusion coefficient values calculated at 300 K.

TABLE 1
Li diffusivity obtained by the NEB method

| Defect | Mechanism | E^{b} (eV) | D_{Li} (cm²/s) |
|---|---|---|---|
| Li vacancy | Vacancy diffusion | 0.77 | 4.8 × 10⁻¹⁷ |
| Interstitial Li | Interstitial hopping | 0.79 | 2.2 × 10⁻¹⁷ |
| Interstitial Li | Interstitial knock-off | 0.7 | 7.2 × 10⁻¹⁷ |

The range of calculated diffusion coefficients was consistent with results reported in the literature. Previously, the Li migration energy barrier was calculated along a major diffusion pathway in crystalline LiF from DFT with reported values of 0.73 eV. Also, previously, the DFT analysis of defect thermodynamics revealed that Li⁺ diffusivity in LiF is much lower than that in the other SEI inorganic components. A diffusion coefficient of 2.25×10⁻¹⁶ cm²/s for vacancy diffusion was reported. For interstitial Li⁺ diffusion by a direct hopping and knock-off, values of 3.25×10⁻¹⁷ cm²/s and 1.04×10⁻¹⁶ cm²/s, respectively, were obtained. To complete the analysis, the vacancy pair point defects were considered in addition to vacancies and interstitials with excess charge. The associated diffusion coefficients were reported in the order of 10⁻²² to 10⁻¹⁶ cm²/s. In a DFT study on an interfacial grain boundary (GB) structure of crystalline LiF, Ramasubramanian and co-workers reported Li⁺ diffusion coefficients of 4.60×10⁻¹² cm²/s and 3.16×10⁻¹⁹ cm²/s at 2:5 type GB and Σ3 type GB, respectively. Using classical molecular dynamics, Benitez and Seminario made a direct calculation of 3.93×10⁻¹² cm²/s as the approximate Li⁺ diffusivity in crystalline LiF at 300 K, based on an analysis of a mean squared displacement (MSD). In studies beyond atomistic simulations, Guan and co-workers used the phase-field model together with Fick's law to report a Li diffusion coefficient in the range of 3.7×10⁻¹² cm²/s at ˜300 K within crystalline LiF. Thus, considering a range of methods like phase-field, molecular dynamics, and NEB calculations for diffusivity estimation, reported D_{Li} values in crystalline LiF are within the range of 10-22 to 10⁻¹² cm²/s, which is consistent with NEB calculations obtained in this example and shown in FIGS. 1A-1B.

### Example 2

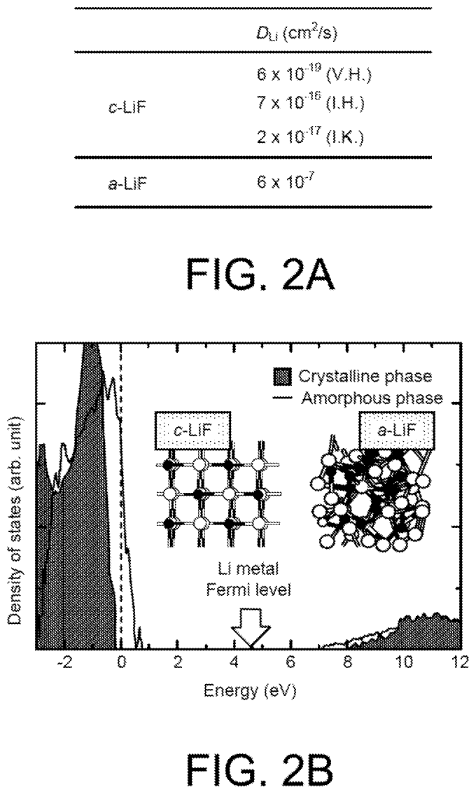

The variation in room-temperature diffusivity of Li in the amorphous phase of LiF (a-LiF) was investigated using AIMD simulations. The mean-square displacements (MSD) of Li atoms were calculated with varying temperatures; MSD=|Rᵢ(t)−Rᵢ(0)|², where Rᵢ(t) is the position of atom i at time t. Based on the MSD profiles, the self-diffusion coefficients for Li were computed using the Einstein relation, D_{Li}=<MSD>/6t, where the angular bracket denotes the ensemble average over the AIMD interval. The logarithm of D_{Li} values tends to follow a linear trend with respect to the reciprocal of temperature, and an Arrhenius functional form is subsequently fitted to the plot of D_{Li} against the inverse of temperature. From the fit, the Li self-diffusion coefficient at 300K in amorphous LiF is estimated to be approximately 6×10⁻⁷ cm²/sec (FIG. 2A), which is several orders of magnitude higher than 10⁻²²˜10⁻¹² cm²/s as predicted for D_{Li} in c-LiF. Making use of the diffusivity and the Nemst-Einstein relation, ionic conductivity can be approximated by

$$σ = \frac{{ne}^{2} {z}^{2}}{{k}_{B} T} {D}_{Li} ,$$

where n is the diffusing particle (Li) density, e is the elementary charge, k_{B} is the Boltzmann constant, and T is the temperature in Kelvin. The Li ionic conductivity determined in this manner is found to be about 15 mS/cm for amorphous LiF, which is comparable to the conductivity of Li in conventional liquid electrolytes and sulfide-based solid-state electrolytes.

To gain insight into the structure effect on electronic properties of LiF, the calculated electronic density of states of bulk a-LiF and c-LiF are compared in FIG. 2B; here, the Li 1s core level is used as a common reference with respect to which each density of states is shifted. The crystalline phase of LiF is known to have a large bandgap of 14 eV, while the DFT-GGA calculations significantly underestimate it. Upon amorphization, the conduction band minimum (CBM) and the valence band maximum (VBM) shift down and up, respectively, leading to band gap reduction by less than 25% in comparison to the crystalline structure. Despite the band gap narrowing, a-LiF is still seen to provide a significant gap and retains its unique electron blocking ability. This combination of anomalously enhanced Li transport properties and insulating character makes amorphous LiF highly desirable as a passivating material at the anode-electrolyte interface.

### Example 3

To investigate whether a-LiF can be formed and sustained without transformation into the crystalline configuration, a phase-dependent energy-volume analysis was conducted. Building both bulk c-LiF and bulk a-LiF structures with comparable system sizes, the energy (E) dependence on volume (V) of the configurations by fitting the Murnaghan equation of state to the E-V curve was determined. The equation of state is given by:

$$E ( V ) = {E}_{0} + ( \frac{BV}{B ′} ) [ \frac{{( \frac{{V}_{0}}{V} )}^{B ′}}{{B}^{′} - 1} + 1 ] - \frac{{BV}_{0}}{{B}^{′} - 1}$$

Here, E refers to the total energy of each bulk LiF supercell at volume V and the subscript 0 indicates their values at equilibrium. B is the bulk modulus that can be further derived from this fit, and B/ is the pressure derivative of the bulk modulus. In the calculations presented herein, hydrostatic tensile and compressive stresses are imposed to achieve incremental volume variation (about ±3%), corresponding to which the total energies of the systems are recorded.

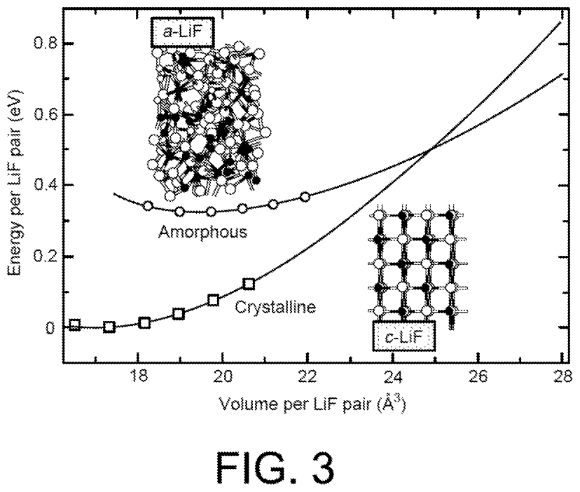

FIG. 3 shows the variations of E with V for a-LiF and c-LiF. At equilibrium, the crystalline structure is predicted to be 0.33 eV (per Li—F pair) more favorable than the amorphous structure, while the volume of the former is smaller by ˜2 Å³ per Li—F pair. By fitting the calculated E-V data to the third-order BM equation, it can be clearly seen that the E of the crystalline structure increases more rapidly with increasing V than that of the amorphous structure. Therefore, the energy gap between the two structures reduces with the increase of V, and the intersection point at ˜25% volumetric strain represents the crossover in V that favors the amorphous phase. This analysis clarifies that it is difficult to achieve stability of the a-LiF phase under ambient strain-free conditions.

### Example 4

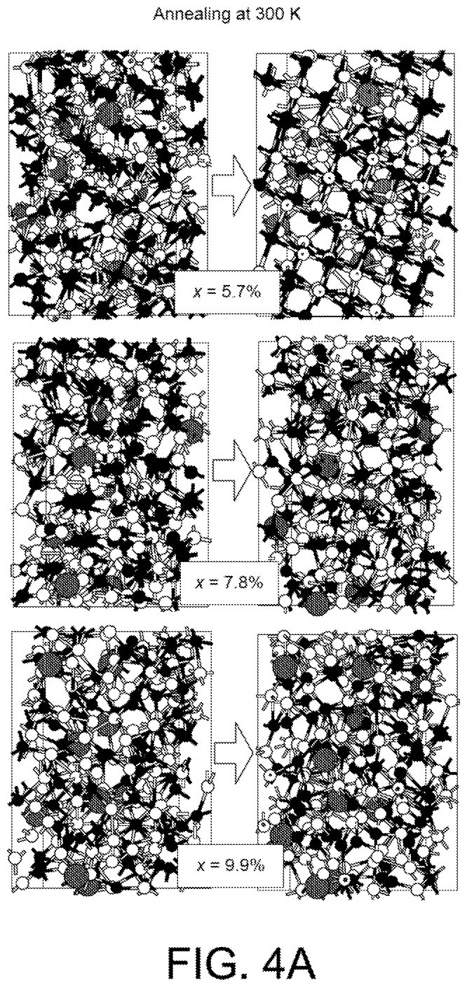

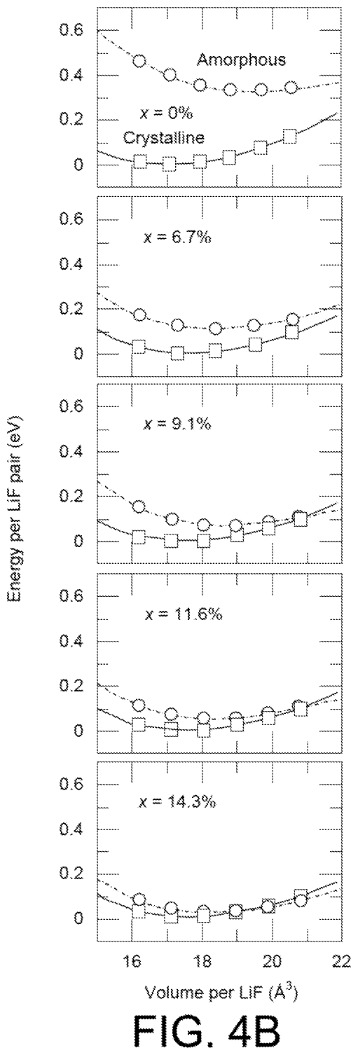

This example investigated configurational stability based on incorporating a heteroatom into the LiF matrix. Nitrogen (N) can be a good candidate to be a stable dopant in LiF as it tends to strongly interact with Li forming Li₃N. To examine the N doping effect, a few N-doped amorphous LiF systems were constructed and referred to as a-LiF(N) hereafter, by randomly replacing 2n number of F atoms with n N and n Li atoms, followed by volume relaxation. Then, AIMD simulations were performed to evaluate structural changes in the LiF(N) systems during NVT relaxations at 300K over 25 ps. FIG. 4A shows the equilibrated LiF(N) structures for three different N contents, each of which contains n Li3N and (108-2n) LiF; n is a non-negative integer (≥0). Here, the percentage of the doping concentration is given as x=N_{N}/(N_{N}+N_{F})×100%, where N_{N} and N_{F} are the number of N and F atoms in a LiF(N) system. In the case of a very low N content (x=5.7%), the amorphous-to-crystalline transformation of LiF is observed. At higher N contents (x=7.8% and x=9.9%), however, amorphous LiF configurations appear to achieve some amount of stability; that is, no phase transformation is seen during the time span of AIMD (25 ps).

To confirm the potential effect of N doping on stabilization of the amorphous LiF phase, crystalline and amorphous N-doped LiF(N) systems were constructed, and their relative stabilities by varying the N content were compared. FIG. 4B shows the relative total energies of the crystalline and amorphous LiF(N) structures as a function of volume from the DFT calculations. Without wishing to be bound by any theory, it was found that the energy difference between the two structures decreases as the N content increases, implying that N doping can greatly contribute to the amorphous phase stabilization of LiF. Again without wishing to be bound by any theory, considering the effect of configurational entropy, it is assumed that the amorphous LiF phase could be achieved with an N content of even less than 10% at finite temperatures as demonstrated earlier by the AIMD simulations at 300K. In addition, the mixing-energy calculations show the favorable incorporation of N in the LiF matrix instead of phase separation into Li₃N and LiF. In a-LiF(N), each anionic N is surrounded by eight (8) Li cations forming N-centered polyhedra, which remain well dispersed; the nature of Li-dopant interaction tends can play a role in stabilizing the a-LiF phase.

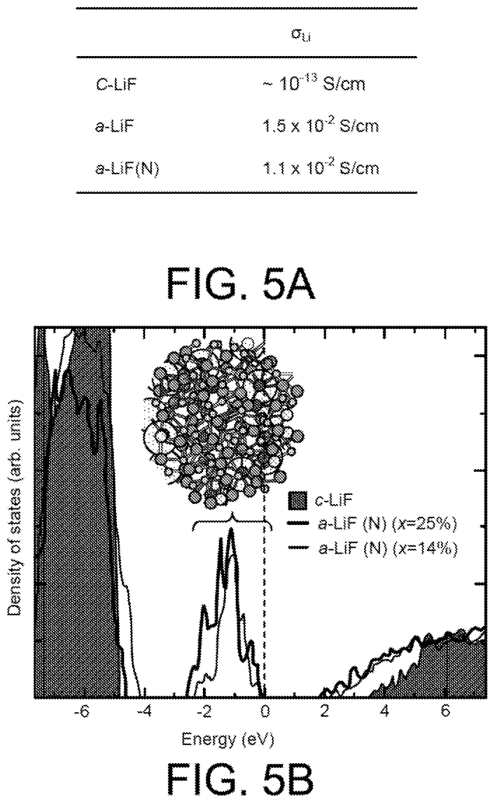

The electronic structure of LiF modified in association with N incorporation was examined. FIG. 5B shows the calculated DOS of a-LiF(N) with two different N contents (x=14%, 25%). Compared to the N-free case (see FIG. 2B), broad localized states appear deep in the band gap. Without wishing to be bound by any theory, it was found that the filled localized states can be apparently induced by the presence of well-dispersed N atoms surrounded by Li atoms, as demonstrated by the isosurface plot of the corresponding band decomposed charge densities. This DOS analysis also shows that the band gap of amorphous LiF is insignificantly affected by N doping. Again, without wishing to be bound by any theory and considering that the doping-induced states are localized and also lie slightly below the Fermi level of Li metal, it was assumed that N-doped LiF(N) can be a good insulating material if the N concentration is kept low enough to ensure the dominance of LiF.

Finally, using a similar method as outlined earlier, the room-temperature diffusivity of Li was computed and was used to estimate the Li-ion conductivity in a-LiF(N). The predicted D_{Li} values are of the same order of magnitude for four different N contents (x=12%, 17%, 25%, 37%), yielding an average ionic conductivity of 0.011 (±0.0006) S/cm (FIG. 5A), which remains substantially unchanged over the rather wide range of N doping levels. Without wishing to be bound by any theory, based on the similar value of Li-ion conductivity to the N-free case, it was hypothesized that the N doping would retain the exceptional Li transport property of amorphous LiF.

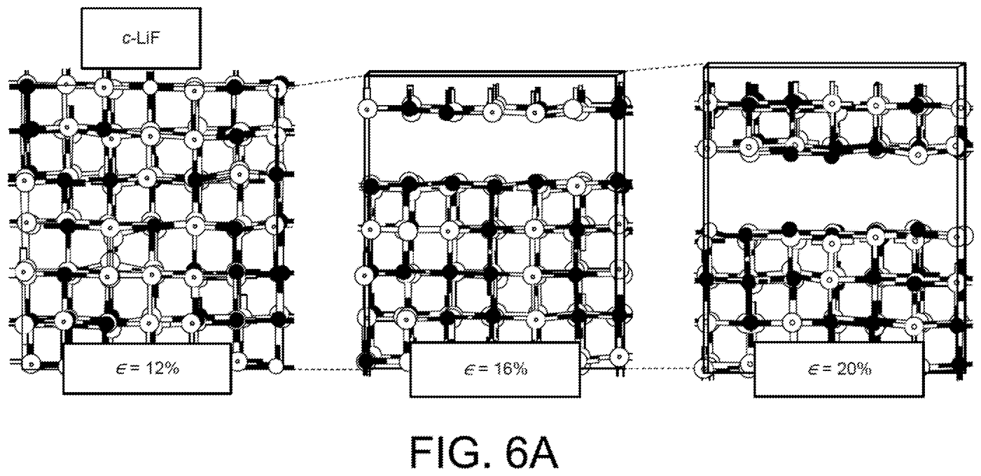

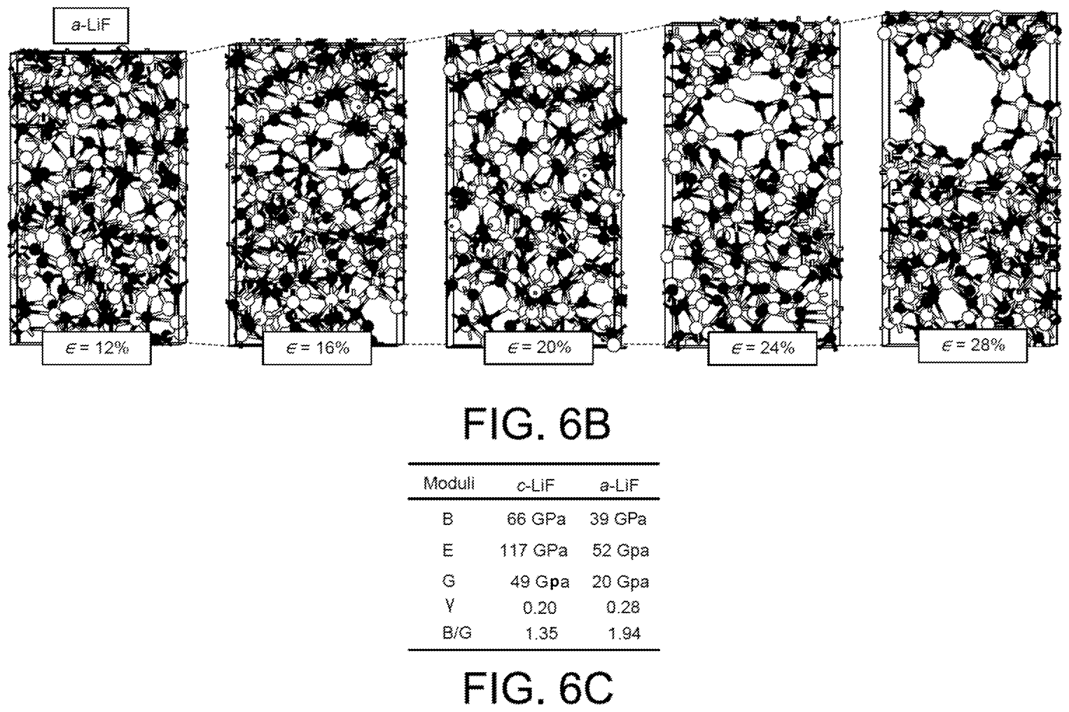

It is also important to investigate the mechanical properties and strain-induced structural response of the SEI components. In order to probe the effect of LiF structure on the elastic properties, the estimated bulk modulus (B), shear modulus (G), elastic modulus (E), and Poisson's ratio (γ), as well as the Pugh's ratio (B/G) were calculated, as tabulated in FIG. 6C. The bulk modulus of a-LiF is found to be lower than that of c-LiF, which is in sync with the behavior of the amorphous phase of a material. Similar trends can be observed from the shear modulus and elastic modulus. Pugh's ratio and Poisson's ratio are considered as indicators to predict the failure mode, i.e., the brittle or ductile nature, of materials. The critical B/G value for material transformation from brittle to ductile is generally considered to be about 1.75. Additionally, the Frantsevich rule points towards a γ value of 0.26 as the separation between brittle and ductile materials. The calculated B/G and γ values for LiF strongly indicate a brittle to ductile transformation accompanying a phase transition from crystalline to amorphous

To corroborate the understanding gleaned from the moduli calculations, AIMD simulations were carried out to subject bulk c-LiF and a-LiF samples under progressive uniaxial straining. To compare the nature of failure in the two configurations, simulation snapshots leading up to strain-induced material fracture are included in FIGS. 6A and 6B. While c-LiF breaks in the form of a clean brittle failure at around 16% strain, a ductile fracture is observed in a-LiF through the progressive coalescence of voids between 20% and 28% strain, ultimately leading to mechanical failure. These results demonstrate a significantly enhanced capacity to accommodate global plastic flow in amorphous LiF, compared to a quick brittle failure seen in the crystalline counterpart.

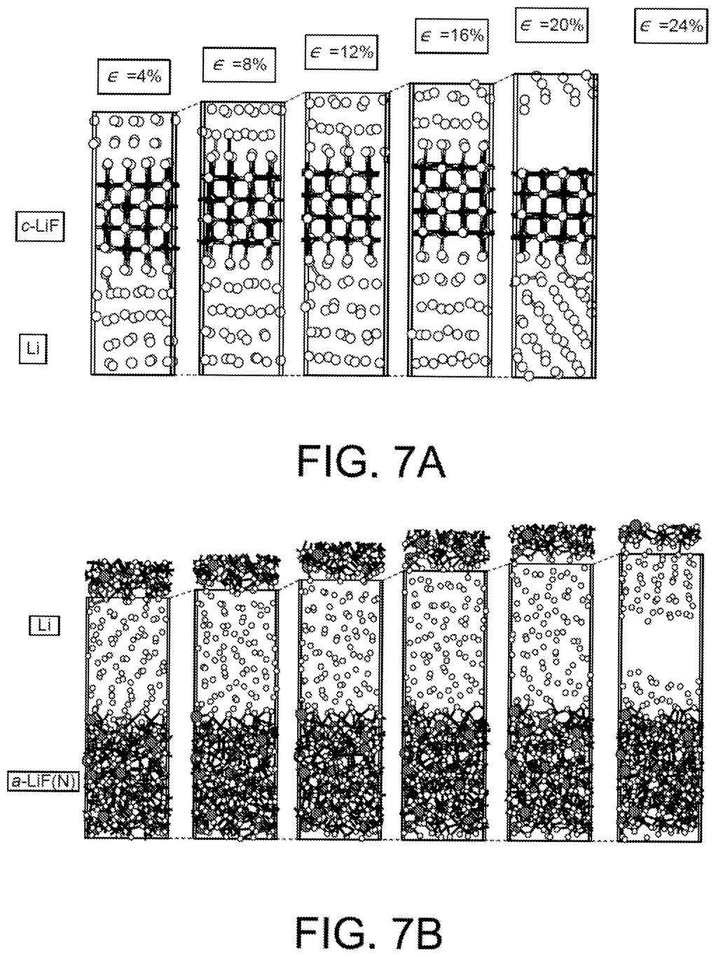

FIG. 7 aims to explore whether there is improved interfacial compatibility between a-LiF and Li to the extent that there can be a change in the nature of the interfacial failure. For this, AIMD simulations were carried out to subject bulk interface structures containing c-LiF and Li, as well as a-LiF and Li under progressive uniaxial straining. To compare the nature of failure in the two configurations, simulation snapshots leading up to strain-induced material fracture are included in FIGS. 7A and 7B. In the case of the Li:c-LiF system, the failure is seen to happen at the interface, while for the Li:a-LiF(N) system, the failure is seen to happen away from the interface, indicating enhanced interfacial compatibility in the latter case, accompanied by a reduction in interfacial impedance.

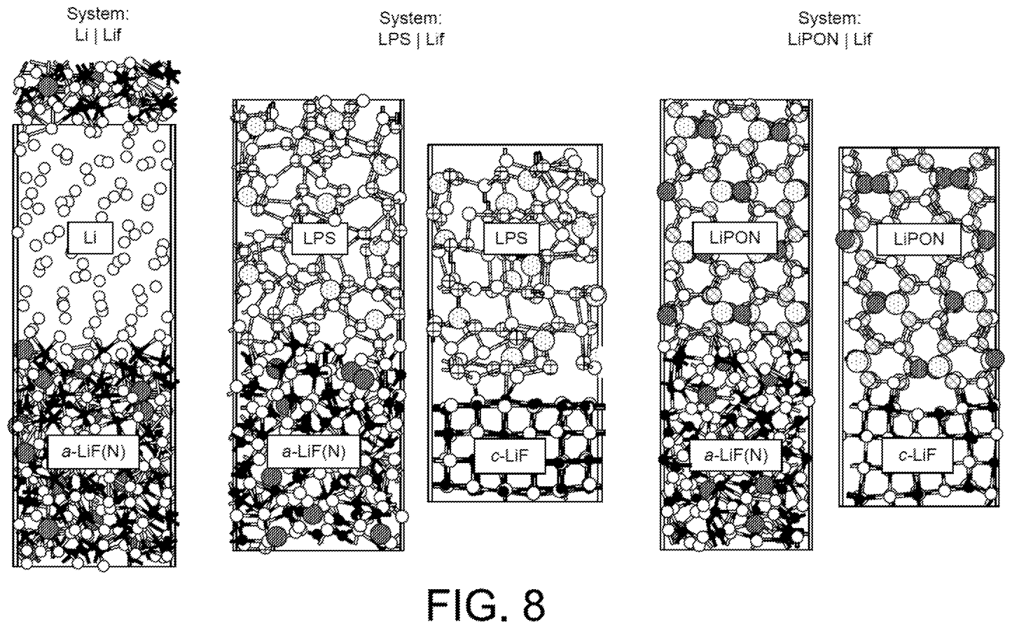

FIG. 8 further shows interfacial compatibility of the amorphous LiF in various systems. It was found that in these systems, the incorporation of heteroatoms and/or polyanions was also desirable to stabilize amorphous Li, maintain favorable transport, electronic, mechanical, and interfacial properties.

The behavior of several different monoanionic as well as polyanionic species as dopants in the LiF network has been studied to arrive at a theoretical understanding of the compositional effect on structure. For this, configurational stability of amorphous LiF by incorporating different impurities in the LiF matrix was investigated. To examine the X doping effect (X=N, O, Si, B, B+N, CO₃), a few X-doped amorphous LiF systems were constructed and referred to as a-LiF(X) hereafter, by randomly replacing N_{R} number of F atoms by N_{X} number of X anions and N_{Y} number of Li atoms, followed by volume relaxation (N_{R}=N_{X}+N_{Y}). The formula unit for the stoichiometric composition of the systems was maintained as xLiF+yLi_{z}X, where Li_{z}X is a stable lithium salt of the anion X. The percentage of the doping concentration is given as n=N_{X}/(N_{X}+N_{F})×100% where N_{X} and N_{F} are the numbers of X and F anionic units in a LiF(X) system. A similar value of doping concentration (n=12%) was maintained initially among all the compositions studied for comparison. Then, AIMD simulations were performed to evaluate structural changes in the LiF(X) systems during NVT relaxations at 300K over 25 ps. Distinctly different agglomeration behavior was observed for embedded dopants Si, B, B—N, when compared to that for N, O, and the oxide polyanions. In the former cases, the interaction of Si and B with Li was weak, and instead of forming stable lithiated dusters, they showed segregation tendencies. For instance, Si was seen to segregate as a chain-like network within the LiF matrix. B too linked up in the form of boron dimers, while high B—N reactivity was observed in the case when both (B, N) were present, leading to the formation of BN dimers. Without wishing to be bound by any theory, it was assumed that their bonding and segregation behavior meant that interaction with Li was quite weak, and an amorphous-to-crystalline transformation of LiF was observed in the case of Si, B, and B—N containing systems.

On the other hand, N and O are monoanionic species that exhibited strong interaction with Li in the LiF matrix, quickly forming stable lithium subnitride and lithium suboxide clusters. The oxide-based polyanionic specie that was studied (CO₃) also formed Li sheaths around each unit. Such impurities, through their strong lithium bonding interactions, would cause disturbance in the LiF network topology and help stabilize the amorphous LiF phase. This was indicated by the NVT simulations, as in the case of these dopants, amorphous LiF configurations appear to achieve some amount of stability; that is, no phase transformation is seen during the time span of AIMD (25 ps).

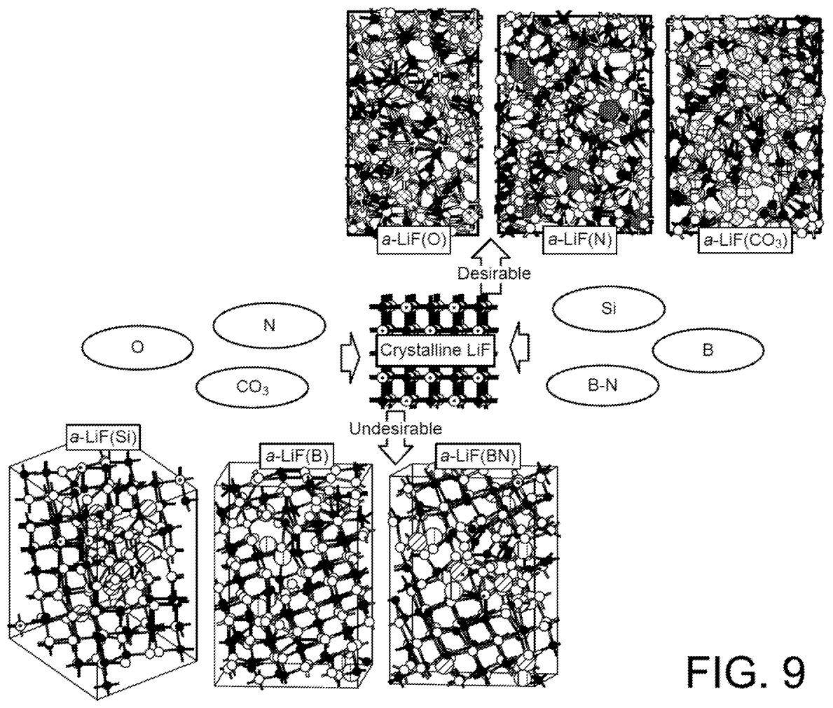

The above point is laid out through a graphical representation in FIG. 9, which shows that in certain aspects, some of the heteroatoms and/or polyanions can cause undesirable effects such as the clustering and/or segregation of the dopants, resulting in the loss of the dopants' ability to engage with the LiF network to stabilize the amorphous LiF phase and the like.

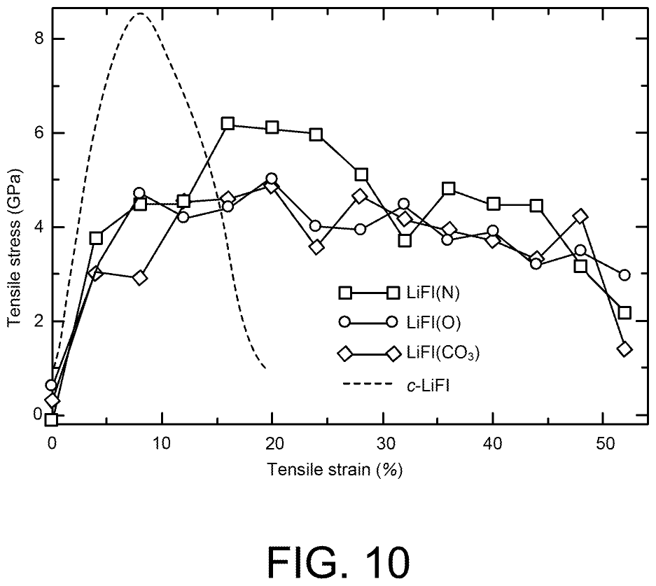

Here as an example, having identified N, O, and O-containing Li-friendly polyanions like CO₃- to be desirable incorporation candidates for stabilization of disordered LiF, a preliminary understanding regarding their influence on the mechanical behavior of LiF was examined. For this, a bulk c-LiF system was constructed, as well as bulk a-LiF(N), a-LiF(O), and a-LiF(CO₃) systems with a similar value of doping concentration (n=25%). AIMD simulations were carried out to subject these samples to progressive uniaxial tensile straining, and the corresponding axial stress-strain responses were examined in FIG. 10. The brittle failure response could be observed for c-LiF, which exhibited an instantaneous loss of capacity to accommodate stress after yielding. The doped amorphous LiF structures, however, undergo appreciable plasticity beginning at ϵzz˜10%: all three compositions accommodate significant plastic flow and remain load bearing even at strains beyond ϵzz˜30%, indicating the truly ductile character of these structures. While voids accumulate as the samples are stretched, the formation of localized, stable lithium sub-nitride and lithium sub-oxide dusters provide strengthening reinforcement to the LiF network.

### Aspects

In view of the described electrode materials, batteries, and methods and variations thereof, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Aspect 1: An electrode material comprising: an anode metal material having an electrochemically active surface; and a substantially inorganic solid electrolyte interphase material, wherein at least a portion of the substantially inorganic solid electrolyte interphase material comprises an amorphous halide salt of one or more metals, wherein the one or more metals comprise the anode metal material, and wherein the substantially inorganic electrolyte interphase material is disposed on the electrochemically active surface.

Aspect 2: The electrode material of Aspect 1, wherein the anode metal material comprises an alkali or an alkaline-earth metal material.

Aspect 3: The electrode material of Aspect 1 or 2, wherein the anode metal material comprises lithium, sodium, potassium, magnesium, aluminum, or alloys thereof.

Aspect 4: The electrode material of any one of Aspects 1-3, wherein the halide salt comprises a chloride salt, a fluoride salt, a bromide salt, an iodide salt of the anode metal material, or a combination thereof.

Aspect 5: The electrode material of any one of Aspects 1-4, wherein the one or more metals further comprise an alkali or an alkaline-earth metal material that is different from the anode metal material.

Aspect 6: The electrode material of any one of Aspects 1-5, wherein the anode metal material is lithium.

Aspect 7: The electrode material of any one of Aspects 1-6, wherein the halide salt is amorphous lithium fluoride.

Aspect 8: The electrode material of any one of Aspects 1-7, wherein the amorphous halide salt is present as a continuous thin film.

Aspect 9: The electrode material of any one of Aspects 1-8, wherein the amorphous halide salt exhibits an ion conductivity ranging from about 1 mS/cm to about 20 mS/cm.

Aspect 10: The electrode material of Aspect 9, wherein the ion conductivity of the amorphous halide salt is about 15 mS/cm.

Aspect 11: The electrode material of any one of Aspects 1-10, wherein a metal anode cation self-diffusion coefficient in the amorphous halide salt is about 5×10⁻¹⁰ to about 10⁻⁷ cm²/s.

Aspect 12: The electrode material of any one of Aspects 1-11, wherein the amorphous halide salt is a substantially electrical insulator.

Aspect 13: The electrode material of Aspect 12, wherein the amorphous halide salt exhibits electrical resistivity greater than about 10⁷ Ω·cm.

Aspect 14: The electrode material of any one of Aspects 1-13, wherein the substantially inorganic solid electrolyte interphase material is the amorphous halide salt.

Aspect 15: The electrode material of any one of Aspects 1-14, wherein the substantially inorganic solid electrolyte interphase material is configured to substantially wet the electrochemically active surface of the anode metal material.

Aspect 16: The electrode material of any one of Aspects 1-15, wherein the substantially inorganic solid electrolyte interphase material exhibits a substantially ductile behavior under stress.

Aspect 17: The electrode material of any one of Aspects 1-16, wherein the interfacial solid electrolyte interphase material is substantially stable at room temperature.

Aspect 18: The electrode material of Aspect 17, wherein the amorphous halide salt film has a volumetric strain greater than 0% and less than 100%.

Aspect 19: The electrode material of Aspect 18, wherein the amorphous halide salt film has the volumetric strain between about 10% to about 30%.

Aspect 20: The electrode material of any one of Aspects 1-19, wherein the amorphous halide salt is doped with at least one heteroatom and/or polyanion.

Aspect 21 The electrode material of Aspect 20, wherein at least one heteroatom and/or polyanion are configured to interchangeably combine with an abutting cation.

Aspect 22: The electrode material of Aspect 20 or 21, wherein at least one heteroatom and/or polyanion is an amorphous phase stabilizer.

Aspect 23: The electrode material of any one of Aspects 20-22, wherein the at least one heteroatom and/or polyanion comprises N, O, C, S, or a combination thereof.

Aspect 24: The electrode material of Aspect 23, wherein the amorphous halide salt is doped with at least one heteroatom and wherein the at least one heteroatom is N.

Aspect 25: The electrode material of any one of Aspects 20-24, wherein the at least one heteroatom and/or polyanion is present in an amount from about 5% to about 500%.

Aspect 26: The electrode material of any one of Aspects 1-25, wherein the substantially inorganic solid electrolyte interphase material is formed ex-situ and/or in-situ when the electrode material is in contact with an electrolyte.

Aspect 27: The electrode material of Aspect 26, wherein the electrolyte is a liquid or solid.

Aspect 28: The electrode material of any one of Aspects 1-27, wherein the substantially inorganic solid electrolyte interphase material is configured to substantially prevent formation of dendrites on the electrochemically active surface of the anode metal material.

Aspect 29: The electrode material of any one of Aspects 26-28, wherein the substantially inorganic solid electrolyte interphase material is configured to substantially suppress decomposition of the electrolyte when it is in contact with the electrolyte.

Aspect 30: A battery comprising the electrode material of any one of Aspects 1-29.

Aspect 31: The battery of Aspect 30 further comprising an electrolyte.

Aspect 32: The battery of Aspect 31, wherein the electrolyte is a liquid.

Aspect 33: The battery of Aspect 31, wherein the electrolyte is a solid.

Aspect 34: The battery of Aspect 33, wherein the substantially inorganic solid electrolyte interphase material is configured to substantially wet a surface of the solid electrolyte that is in contact with the anode metal material.

Aspect 35: The battery of Aspect 34 wherein the electrolyte comprises a salt of a metal cation and a non-aqueous organic solvent.

Aspect 36: The battery of Aspect 35, wherein the metal cation comprises lithium, sodium, potassium, magnesium, aluminum, or a combination thereof.

Aspect 37: The battery of Aspects 35 or 36, wherein the non-aqueous organic solvent comprises an ethylene carbonate, dimethyl carbonate, diethyl carbonate, propylene carbonate, dimethoxyethane, ethyl methyl carbonate, N-methyl acetamide, acetonitrile, symmetric sulfone, sulfolane, polyethylene glycol, 1,3-dioxolane, glymes, siloxane, ethylene oxide grafted sulfolane, or a combination thereof.

Aspect 38: The battery of Aspect 33 or 34, wherein the electrolyte is solid and comprises sulfide compounds, garnet structure oxides, LISICON-type solids, NASICON-type phosphate glass ceramics, perovskite-type and anti-perovskite type compounds, nitrides, oxynitrides, argyrodite-type, or polymer-based electrolytes, or any combination thereof.

Aspect 39: The battery of Aspect 38, wherein the electrolyte comprises a lithium germanium phosphorous sulfide electrolyte, a lithium phosphorus oxynitride electrolyte, a lithium phosphorous sulfide electrolyte, lithium lanthanum zirconium oxide, lithium lanthanum titanium oxide, lithium aluminum germanium phosphate, lithium nitride, or any combination thereof.

Aspect 40: The battery of any one of Aspects 30-39, further comprising a cathode material.

Aspect 41: The battery of Aspect 40, wherein the cathode material is a metal cathode or a composite cathode.

Aspect 42: The battery of Aspect 41, wherein the cathode comprises copper, carbon, graphite, sodium, lithium, layered oxides, spinels, olivines, or any combination thereof.

Aspect 43: The battery of Aspect 42, wherein the cathode comprises a composite material comprising A-MnO₂, LiMn₂O₄ spinel, olivine LiFePO₄, FePO₄, layered LiCoO₂ (LCO), LiNi_{y}Mn_{y}Co_{1-2y}O₂ (NMC), LiNiMnO₂, or any combination thereof.

Aspect 44: The battery of any one of Aspects 40-43, wherein the cathode comprises a LiFePO₄ composite cathode, a LiNi_{0.8}C_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, a LiNi_{0.8}Mn_{0.1}Co_{0.1}O₂ composite cathode.

Aspect 45: The battery of any one of Aspects 40-44, wherein the cathode comprises a poly(ethylene oxide), cellulose, carboxymethylcellulose (CMC), polytetrafluoroethylene (PTFE), styrene-butadiene rubber (SBR), a polyvinylidene fluoride binder; or any combination thereof.

Aspect 46: The battery of any one of Aspects 30-45, wherein the battery is a secondary battery.

Aspect 47: A thin film comprising an amorphous halide salt comprising a metal cation of an alkali metal or alkaline-earth metal.

Aspect 48: The thin film of Aspect 47, wherein the metal cation comprises lithium, sodium, potassium, magnesium, aluminum, or a combination thereof.

Aspect 49: The thin film of Aspect 47 or 48, wherein the halide salt comprises Cl, F, I, Br, or a combination thereof.

Aspect 50: The thin film of any one of Aspects 47-49, wherein the amorphous salt is stable at ambient conditions.

Aspect 51: The thin film of Aspect 50, wherein the amorphous halide salt film has a volumetric strain greater than 0% and less than 100%.

Aspect 52: The thin film of Aspect 51, wherein the amorphous halide salt film has the volumetric strain between about 10% to about 30%.

Aspect 53: The thin film of any one of Aspects 47-52, wherein the amorphous halide salt is doped with at least one heteroatom and/or polyanion.

Aspect 54: The thin film of Aspect 53, wherein at least one heteroatom and/or polyanion are configured to interchangeably combine with an abutting cation.

Aspect 55: The thin film of Aspect 53 or 54, wherein at least one heteroatom and/or polyanion is an amorphous phase stabilizer.

Aspect 56: The thin film of Aspect 55, wherein the at least one heteroatom and/or polyanion comprises N, O, C, S, or a combination thereof.

Aspect 57: The thin film of Aspect 56, wherein the amorphous halide salt is doped with at least one heteroatom and wherein the at least one heteroatom is N.

Aspect 58: The electrode material of any one of Aspects 53-57, wherein the at least one heteroatom and/or polyanion is present in an amount from about 5% to about 500%.

Aspect 59: The thin film of any one of Aspects 47-58, wherein the thin film is the amorphous halide salt.

Aspect 60: A solid ion-conducting composite comprising: a) a thin film solid electrolyte comprising one or more of sulfide compounds, garnet structure oxides, LISICON-type solids, NASICON-type phosphate glass ceramics, perovskite-type and anti-perovskite type compounds, nitrides, oxynitrides, argyrodite-type, polymer-based electrolytes, or any combination thereof, and b) a protective layer comprising the amorphous thin film of any one of Aspects 45-55 disposed on the thin film solid electrolyte surface.

Aspect 61: The solid ion-conducting composite of Aspect 60, wherein the protective layer is configured to substantially wet an electrochemically active surface of an anode metal material if present.

Aspect 62: The solid ion-conducting composite of Aspect 61, wherein the protective layer is configured to substantially prevent formation of dendrites on the electrochemically active surface of the anode metal material.

Aspect 63: The solid ion-conducting composite of any one of Aspects 60-62, wherein the protective layer is configured to substantially suppress decomposition of the thin film solid electrolyte.

Aspect 64: A method of making the electrode material of any one of Aspects 1-29 comprising depositing or in-situ forming the substantially inorganic solid electrolyte interphase material on the electrochemically active surface of the anode metal material.

Aspect 65: The method of Aspect 64, wherein the step of depositing comprises a plasma deposition, an atomic layer deposition, a molecular layer deposition, a chemical vapor deposition, a gas-phase deposition, a solution deposition, an electrochemical deposition, or any combination thereof.

Aspect 66: The method of Aspect 64, wherein the in-situ formation occurs when the anode metal material is in contact with an inorganic solid electrolyte and wherein the substantially inorganic solid electrolyte interphase material is a reaction product between the anode metal material and the electrolyte.

Aspect 67: The method of Aspect 64, wherein the in-situ formation of the substantially inorganic solid electrolyte interphase material comprises: forming a first halide salt on the electrochemically active surface of the anode material prior to contact with an inorganic solid electrolyte; forming a second halide salt on of the inorganic solid electrolyte prior to contact with the electrochemically active surface of the anode material; exposing the electrochemically active surface of the anode material to the inorganic solid electrolyte; wherein the substantially inorganic solid electrolyte interphase material is a reaction product between the first halide salt and the second halide salt.

Aspect 68: A method of making the solid ion-conducting composite of any one of Aspects 60-63 comprising depositing the protective layer on a surface of the thin film solid electrolyte.

Aspect 69: The method of Aspect 68, wherein the step of depositing comprises a plasma deposition, an atomic layer deposition, a molecular layer deposition, a chemical vapor deposition, a gas-phase deposition, a solution deposition, an electrochemical deposition, or any combination thereof

Aspect 66: The method of forming a battery of any one of Aspects 30-47, comprising: a) providing the electrode material of any one of Aspects 1-29; b) providing an electrolyte; and c) providing a cathode material.

### REFERENCES

(1) Chen, Y. C.; Ouyang, C. Y.; Song, L. J.; Sun, Z. L. Electrical and Lithium Ion Dynamics in Three Main Components of Solid Electrolyte Interphase from Density Functional Theory Study. J. Phys. Chem. C 2011, 115, 7044-7049.
(2) Yildirim, H.; Kinaci, A.; Chan, M. K. Y.; Greeley, J. P. FirstPrinciples Analysis of Defect Thermodynamics and Ion Transport in Inorganic Sei Compounds: Lif and Naf. ACS Appl. Mater. Interfaces 2015, 7, 18985-18996.
(3) Ramasubramanian, A.; Yurkiv, V.; Foroozan, T.; Ragone, M.; Shahbazian-Yassar, R.; Mashayek, F. Lithium Diffusion Mechanism through Solid-Electrolyte Interphase in Rechargeable Lithium Batteries. J. Phys. Chem. C 2019, 123 (16), 10237-10245.
(4) Benitez, L.; Seminario, J. M. Ion Diffusivity through the Solid Electrolyte Interphase in Lithium-Ion Batteries. J. Electrochem. Soc. 2017, 164, E3159-E3170.
(5) Guan, P.; Liu, L.; Lin, X. Simulation and Experiment on Solid Electrolyte Interphase (SEI) Morphology Evolution and Lithium-Ion Diffusion. J. Electrochem. Soc. 2015, 162, A1798-A1808.

1. An electrode material comprising:
an anode metal material having an electrochemically active surface; and
a substantially inorganic solid electrolyte interphase material, wherein at least a portion of the substantially inorganic solid electrolyte interphase material comprises an amorphous halide salt of one or more metals, wherein the amorphous halide salt exhibits an ion conductivity ranging from 1 mS/cm to about 20 mS/cm;
wherein the one or more metals comprise the anode metal material, and
and wherein the substantially inorganic electrolyte interphase material is disposed on the electrochemically active surface.

2-4. (canceled)

5. The electrode material of claim 1, wherein the anode metal material is lithium.

6. The electrode material of claim 1, wherein the halide salt is amorphous lithium fluoride.

7. The electrode material of claim 1, wherein the substantially inorganic solid electrolyte interphase material is present as a continuous thin film; and/or
the amorphous halide salt is a substantially electrical insulator.

8-9. (canceled)

10. The electrode material of claim 1, wherein a self-diffusion coefficient of a cation of the anode metal material in the amorphous halide salt is 5×10⁻¹⁰-10⁻⁷ cm²/s.

11. (canceled)

12. The electrode material of claim 7, wherein the amorphous halide salt exhibits electrical resistivity greater than about 10⁷ Ω·cm.

13. The electrode material of claim 1, wherein the substantially inorganic solid electrolyte interphase material is the amorphous halide salt.

14-17. (canceled)

18. The electrode material of claim 1, wherein the amorphous halide salt film has a volumetric strain between about 10% to about 30%.

19. The electrode material of claim 1, wherein the amorphous halide salt is doped with at least one heteroatom and/or polyanion comprising N, O, C, S, or a combination thereof, wherein the at least one heteroatom and/or polyanion is present and in an amount from about 5% to about 500%, and wherein at least one heteroatom and/or polyanion are configured to interchangeably combine with an abutting cation.

20-24. (canceled)

25. The electrode material of claim 1, wherein the substantially inorganic solid electrolyte interphase material is formed ex-situ and/or in-situ when the electrode material is in contact with an electrolyte.

26. (canceled)

27. The electrode material of claim 1, wherein the substantially inorganic solid electrolyte interphase material is configured to substantially prevent formation of dendrites on the electrochemically active surface of the anode metal material, and/gr wherein the substantially inorganic solid electrolyte interphase material is configured to substantially suppress decomposition of an electrolyte when it is in contact with the electrolyte.

28. (canceled)

29. A battery comprising:
the electrode material of claim 1;
an electrolyte, wherein the electrolyte is a liquid or a solid electrolyte; and
a cathode material.

30-33. (canceled)

34. The battery of claim 29, wherein the electrolyte comprises a salt of a metal cation and a non-aqueous organic solvent, wherein the metal cation comprises lithium, sodium, potassium, magnesium, aluminum, or a combination thereof, and/or wherein the non-aqueous organic solvent comprises an ethylene carbonate, dimethyl carbonate, diethyl carbonate, propylene carbonate, dimethoxyethane, ethyl methyl carbonate, N-methyl acetamide, acetonitrile, symmetric sulfone, sulfolane, polyethylene glycol, 1,3-dioxolane, glymes, siloxane, ethylene oxide grafted sulfolane, or a combination thereof.

35-36. (canceled)

37. The battery of claim 29, wherein when the electrolyte is solid and comprises sulfide compounds, garnet structure oxides, LISICON-type solids, NASICON-type phosphate glass ceramics, perovskite-type and anti-perovskite type compounds, nitrides, oxynitrides, argyrodite-type, or polymer-based electrolytes, or any combination thereof.

38-39. (canceled)

40. The battery of claim 29, wherein the cathode material is a metal cathode or a composite cathode.

41. The battery of claim 40, wherein the cathode comprises copper, carbon, graphite, sodium, lithium, layered oxides, spinels, olivines, or any combination thereof.

42. The battery of claim 41, wherein the cathode comprises a composite material comprising λ-MnO₂, LiMn₂O₄ spinel, olivine LiFePO₄, FePO₄, layered LiCoO₂ (LCO), LiNi_{y}Mn_{y}Co_{1-2y}O₂ (NMC), LiNiMnO₂, or any combination thereof.

41-58. (canceled)

59. A solid ion-conducting composite comprising:
a) a thin film solid electrolyte comprising one or more of sulfide compounds, garnet structure oxides, LISICON-type solids, NASICON-type phosphate glass ceramics, perovskite-type and anti-perovskite type compounds, nitrides, oxynitrides, argyrodite-type, polymer-based electrolytes, or any combination thereof, and
b) a protective layer comprising an amorphous thin film disposed on the thin film solid electrolyte surface, wherein the amorphous thin film comprises:
i) a metal cation comprising lithium, sodium, potassium, magnesium, or a combination thereof; and
j) the halide comprising Cl, F, L Br, or a combination thereof;
wherein the amorphous halide salt film has the volumetric strain between about 10% to about 30%; and/or
wherein the amorphous halide salt is doped with at least one heteroatom and/or polyanion comprising N, O, C, S, or a combination thereof that is present an amount from about 5% to about 500%, and wherein at least one heteroatom and/or polyanion are configured to interchangeably combine with an abutting cation.

60-62. (canceled)

63. A method of making the electrode material of claim 1 comprising depositing or in-situ forming the substantially inorganic solid electrolyte interphase material on the electrochemically active surface of the anode metal material, wherein the step of depositing comprises a plasma deposition, an atomic layer deposition, a molecular layer deposition, a chemical vapor deposition, a gas-phase deposition, a solution deposition, an electrochemical deposition, or any combination thereof, and/or
the in-situ formation occurs when the anode metal material is in contact with an inorganic solid electrolyte and wherein the substantially inorganic solid electrolyte interphase material is a reaction product between the anode metal material and the electrolyte.

64-65. (canceled)

66. The method of claim 63, wherein the in-situ formation of the substantially inorganic solid electrolyte interphase material comprises:
forming a first halide salt on the electrochemically active surface of the anode material prior to contact with an inorganic solid electrolyte;
forming a second halide salt on the inorganic solid electrolyte prior to contact with the electrochemically active surface of the anode material; and
exposing the electrochemically active surface of the anode material to the inorganic solid electrolyte; wherein the substantially inorganic solid electrolyte interphase material is a reaction product between the first halide salt and the second halide salt.

67-69. (canceled)
